(19) United States
(12) Patent Application Publication
(10) Pub. No.: US 2018/0091277 A1
(43) Pub. Date: Mar. 29, 2018

(54) SCRAMBLING AND MODULATION OF CHANNEL STATE INFORMATION REFERENCE SIGNALS (CSI-RS) FOR FULL-DIMENSIONAL MULTIPLE-INPUT-MULTIPLE-OUTPUT (FD-MIMO) SYSTEMS

(71) Applicant: Intel Corporation, Santa Clara, CA (US)

(72) Inventors: Alexei Davydov, Nizhny Novgorod (RU); Gregory Morozov, Nizhny Novgorod (RU); Gi Wan Choi, San Jose, CA (US)

(21) Appl. No.: 15/564,609

(22) PCT Filed: Aug. 31, 2015
(86) PCT No.: PCT/US2015/047734

§ 371 Date: Oct. 5, 2017

Related U.S. Application Data
(60) Provisional application No. 62/158,677, filed on May 8, 2015.

(51) Int. Cl. H04L 5/00; H04L 27/18

(52) U.S. Cl. CPC H04L 5/0053; H04W 84/042; H04L 27/18

(57) ABSTRACT

Techniques for modulating and scrambling channel state information reference signals (CSI-RS) for more than eight antenna ports are discussed. One example system employing such techniques can include a processor and transmitter circuitry. The processor can be configured to determine CSI-RS signal parameters for a user equipment (UE) and modulate a plurality of CSI-RS signals based on a modulation sequence. The transmitter circuitry can be configured to transmit the CSI-RS signal parameters and the modulated plurality of CSI-RS signals to the UE. Each of the plurality of CSI-RS signals can be associated with a distinct CSI-RS antenna port of a plurality of CSI-RS antenna ports of the transmitter circuitry, and the modulation sequence can be based at least in part on indices of the CSI-RS antenna ports or subcarriers associated with the plurality of CSI-RS signals.

### REFERENCE TO RELATED APPLICATIONS

This application claims the benefit of U.S. Provisional Application No. 62/158,677 filed May 8, 2015, entitled “METHOD OF SCRAMBLING AND MODULATION OF CSI-RS FOR FD-MIMO SYSTEMS IN LTE-A”, the contents of which are herein incorporated by reference in their entirety.

### FIELD

The present disclosure relates to wireless technology, and more specifically to techniques for scrambling and modulation of channel state information (CSI) reference signals (CSI-RS) in connection with full dimensional (FD) multiple input multiple output (FD-MIMO) systems.

### BACKGROUND

Channel State Information (CSI) reference signals (RS) were introduced in the Long Term Evolution (LTE)-Advanced (LTE-A) specification in release 10 (Rel-10) to support channel measurements for CSI calculation and reporting. The CSI-RS of conventional LTE systems supports up to 8 antenna ports {15-22} and within one subframe have a density of 1 resource element (RE) per antenna port per pair of physical resource blocks (PRBs).

Multiple-input-multiple-output (MIMO) technology in LTE-A Rel-8 and subsequent MIMO enhancements in Rel-10 and Rel-11 were designed to support antenna configurations at the Enhanced NodeB (eNB) that are capable of adaptation in azimuth only. Recently, there has been significant interest in enhancing system performance through the use of antenna systems having a two-dimensional array structure (with potentially more than 8 antennas) that provides adaptive control over both the elevation dimension and the azimuth dimension.

### BRIEF DESCRIPTION OF THE DRAWINGS

FIG. 1 is a block diagram illustrating an example user equipment (UE) useable in connection with various aspects described herein.

FIG. 2 is an example time-frequency chart of a subframe illustrating possible resource elements (REs) used for transmitting channel state information reference signals (CSI-RS) for 8 antenna ports.

FIG. 3 is an illustration of an example scenario implementing elevation beamforming in a FD-MIMO system, showing an example Enhanced NodeB (eNB) employing elevation beamforming to transmit to a plurality of UEs at different elevations.

FIG. 4 is a block diagram illustrating an example system that facilitates scrambling and modulation of more than eight CSI-RS antenna ports (e.g., 16, 24, 32, 64, etc.) according to various aspects described herein.

FIG. 5 is an example time-frequency chart of a subframe illustrating possible REs used for transmitting CSI-RS for 32 antenna ports according to various aspects described herein.

FIG. 6 is an example time-frequency chart of a subframe illustrating possible REs used for transmitting CSI-RS for up to 40 antenna ports according to various aspects described herein.

FIG. 7 is a flow diagram illustrating an example method facilitating scrambling and modulation of greater than eight CSI-RS antenna ports according to various aspects described herein.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

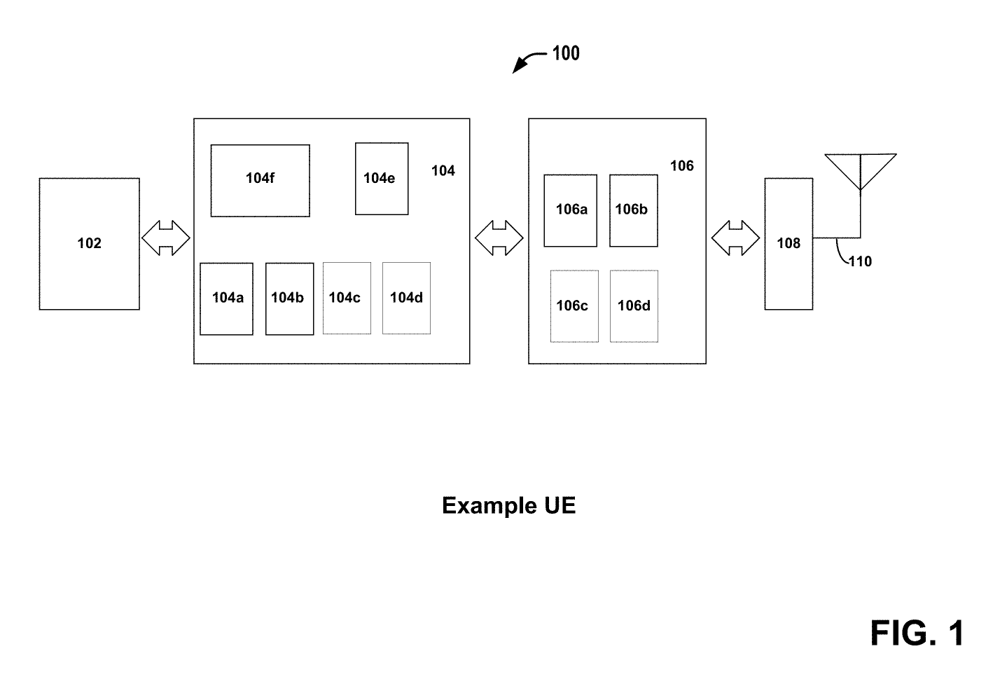

Embodiments described herein may be implemented into a system using any suitably configured hardware and/or software. FIG. 1 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuity 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory/storage, display, camera, sensor, and/or input/output (I/O) interface.

In accordance with various embodiments described herein, techniques can be employed to provide for modulation and scrambling of channel state information (CSI) reference signals (RSs) for a number of antenna ports greater than eight. In aspects, different sequences can be employed for modulating different CSI-RSs based on antenna port indices associated with the CSI-RSs. In other aspects, different sequences can be employed for modulating different CSI-RSs based on subcarrier indices associated with the CSI-RSs. In some embodiments, to support backwards compatibility of CSI-RS transmission, CSI-RS port-specific scrambling can be applied starting from an Nth antenna port of the CSI-RS antenna ports, where N can be a predefined value such as 8 or a parameter provided to the UE via higher layer signaling.

Conventional LTE-A systems provide for CSI-RS for up to 8 antenna ports. For 8 antenna ports, the reference signals of antenna ports {15, 16}, {17, 18}, {19, 20}, and {21, 22} are multiplexed on two adjacent in time REs using orthogonal complementary codes (OCCs) of {1, 1} (for antenna ports 15, 17, 19, and 21) and {1, −1} for antenna ports 16, 18, 20, and 22). In the time domain, CSI-RS is transmitted periodically with periods which are multiples of 5 ms (or 5 subframes). The CSI-RS are transmitted only on the downlink subframes.

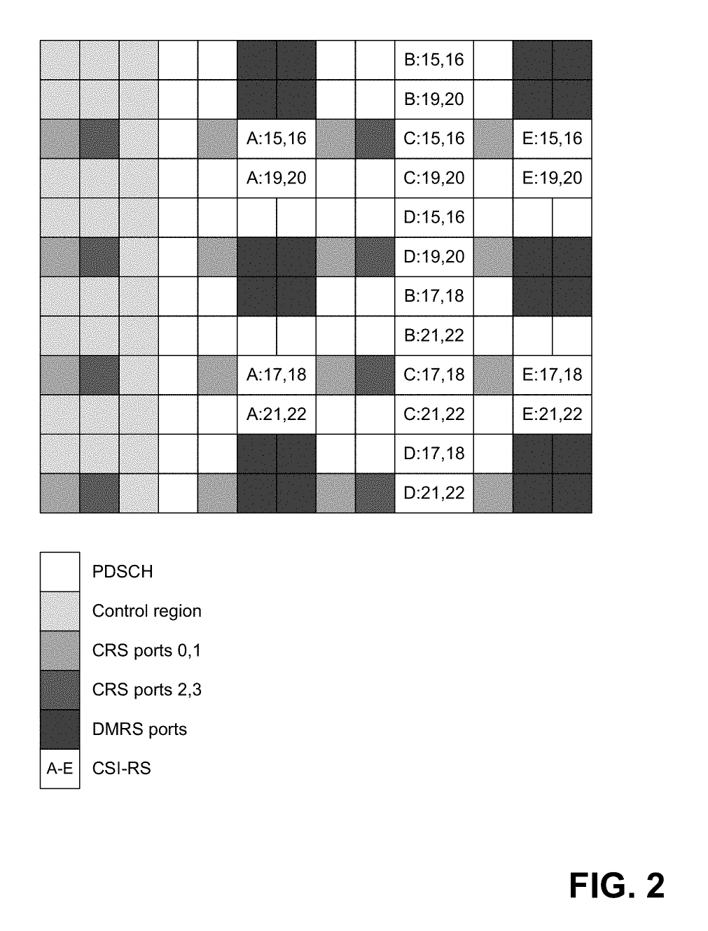

Referring to FIG. 2, illustrated is an example time-frequency chart of a subframe indicating possible REs used for transmitting CSI-RS for 8 antenna ports. Five different possible CSI-RS configurations for antenna ports {15-22} are shown, labeled ‘A’ through ‘E,’ only one of which will be used. The actual CSI-RS configuration employed, the number of CSI-RS antenna ports, and the subframe periodicity and offset can all be configured to a user equipment (UE) via higher layer signaling.

In conventional LTE systems, the CSI-RS reference symbols are modulated using quadrature phase shift keying (QPSK) complex symbols, which are determined according to a pseudo-random sequence. The pseudo-random sequence is initialized every orthogonal frequency division multiplexing (OFDM) symbol, and also depends on the virtual or the physical cell identity of the transmitting cell, slot index within the radio frame, and cyclic prefix length. To keep orthogonal multiplexing, the pseudo-random sequence is the same for the two CSI-RS signals corresponding to the following pairs of antenna ports: {15, 16}, {17, 18}, {19, 20}, and {21, 22}. Additional details regarding CSI-RS modulation in conventional LTE systems is provided in LTE-A technical specification (TS) 36.211 v.12.5.0.

In conventional LTE systems, the reference signal sequence r_{l,n}_{ₛ} is defined as in equation 1,

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1 , \qquad ( 1 )$$

where nₛ is the slot number within a radio frame and l is the OFDM symbol number within the slot. The pseudo-random sequence c(i) is defined in clause 7.2 of LTE-A TS 36.211 v.12.5.0, and initialized with cᵢₙᵢₜ=2¹⁰. (7·(nₛ+1)+l+1)·(2·N_{ID}^{CSI}+1)+2·N_{ID}^{CSI}+N_{CP} at the start of each OFDM symbol, where N_{CP} is 1 for normal cyclic prefix (CP) and 0 for extended CP, and N_{ID}^{CSI} equals the physical cell ID N_{ID}^{cell} unless configured by higher layers.

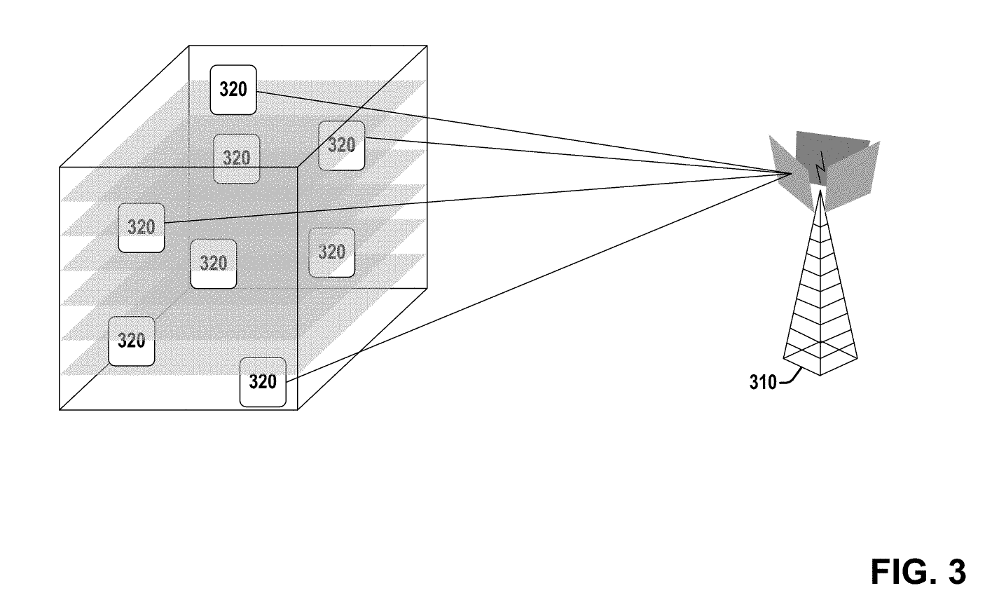

Elevation beamforming and full dimensional (FD) can involve antenna arrays that have potentially more than 8 antennas, which exceeds the number of antennas provided for CSI-RS in conventional LTE-A systems. These two-dimensional antenna arrays can provide for control over both the elevation and azimuth directions, in contrast to conventional systems with one-dimensional arrays providing control over solely the azimuth direction. The additional control over the elevation dimension enables a variety of strategies such as sector-specific elevation beamforming (e.g., adaptive control over the vertical pattern beamwidth and/or downtilt), advanced sectorization in the vertical domain, and user-specific elevation beamforming. Vertical sectorization can improve average system performance through the higher gains of the vertical sector patterns, but vertical sectorization generally does not need additional standardization support. User equipment (UE)-specific elevation beamforming promises to increase the signal-to-interference-plus-noise ratio (SINR) statistics seen by the UEs by pointing the vertical antenna pattern in the direction of the UE, while spraying less interference to adjacent sectors by virtue of being able to steer the transmitted energy in elevation. FIG. 3 illustrates an example scenario implementing elevation beamforming in a FD-MIMO system, showing an example eNB 310 employing elevation beamforming to transmit to a plurality of UEs 320 at different elevations.

In conventional LTE-A systems, a common scrambling sequence is used for modulation of CSI-RS corresponding to different antenna ports. Antenna port dependent scrambling is important to de-correlate interference created from CSI-RS and reduce the peak-to-average power ratio (PAPR).

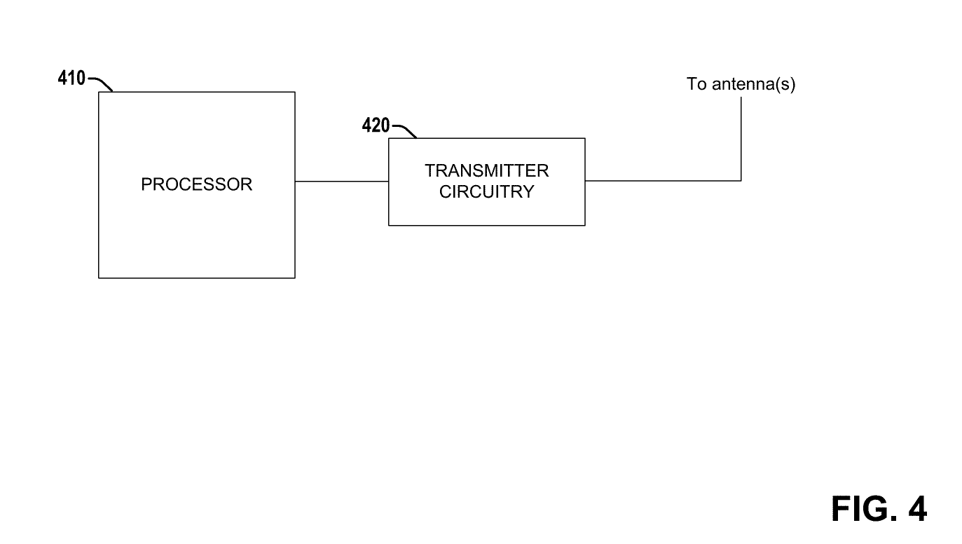

Referring to FIG. 4, illustrated is a block diagram of a system 400 that facilitates scrambling and modulation of more than eight CSI-RS antenna ports (e.g., 16, 24, 32, 64, etc.) according to various aspects described herein. System 400 can include a processor 410, and transmitter circuitry 420. In various aspects, system 400 can be included within an Evolved Universal Terrestrial Radio Access Network (E-UTRAN) Node B (Evolved Node B, eNodeB, or eNB) or other base station in a wireless communications network. As described in greater detail below, system 400 can configure CSI-RS signal parameters to a UE, modulate CSI-RS signals for a plurality of CSI-RS antenna ports (which can exceed the conventional LTE-A maximum number of 8 CSI-RS antenna ports), and transmit the modulated CSI-RS signals to the UE.

Processor 410 can generate signal parameters for a UE for CSI-RS modulation and transmission, for subsequent decoding of the CSI-RS by the UE. These signal parameters can be configured to the UE via higher layer signaling. Additionally, processor 410 can modulate the plurality of CSI-RS signals, which can be in accordance with the signal parameters configured to the UE. This modulation can involve multiplexing pairs of CSI-RS (e.g., 15 with 16, 17 with 18, etc.) via pairs of orthogonal complementary codes (OCCs) and modulation using quadrature phase shift keying (QPSK) complex symbols. To avoid the highly correlated interference across subcarriers that can result from employing the same symbols, various techniques can be employed to vary the modulation, randomizing interference for neighboring subcarriers, and improving performance for larger numbers of CSI-RS signals (e.g., more than eight).

Transmitter circuitry 420 can transmit the CSI-RS signal parameters for the UE, and can transmit the CSI-RS signals modulated by processor 410. Transmitter circuitry 420 can transmit the CSI-RS signals every n milliseconds, where n can be a multiple of 5. When transmitted, the CSI-RS signals can each be assigned to a resource element (RE) in accordance with the parameters configured to the UE via higher layers. In aspects, for CSI-RS signals for up to 40 antenna ports, each of the CSI-RS signals can be transmitted in the same subframe, and can be assigned to an RE associated with one of the CSI-RS signal patterns employed in conventional LTE-A systems (e.g., the patterns labeled ‘A’-‘E’ in FIG. 2). For embodiments with more than 40 antenna ports (or for some embodiments with 40 or less antenna ports), the set of CSI-RS signals (e.g., 64, etc.) can be transmitted over more than one subframe.

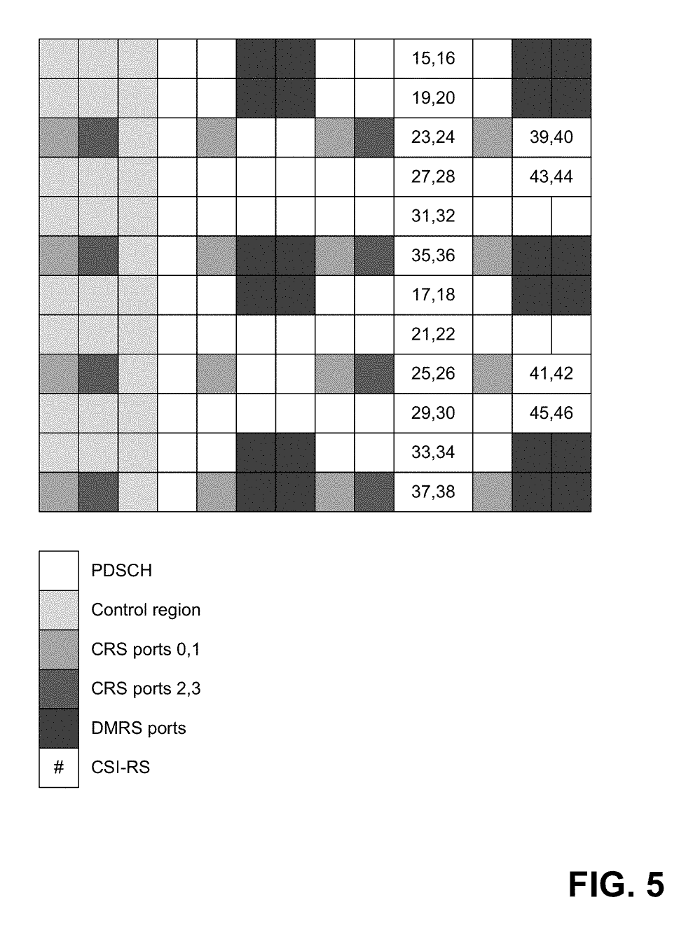

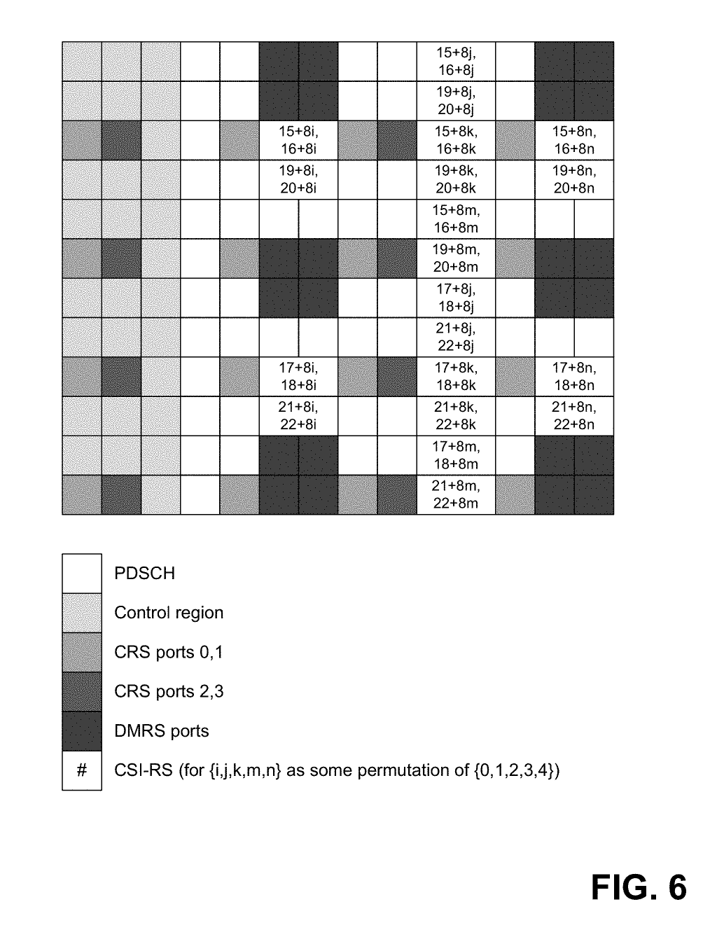

In one example, for 16 CSI-RS antenna ports, the CSI-RS signals can be transmitted in the REs associated with any two of the patterns ‘A,’ ‘B,’ ‘C,’ ‘D,’ or ‘E’ in FIG. 2. Referring to FIG. 5, illustrated is an example time-frequency chart of a subframe indicating possible REs used for transmitting CSI-RS for 32 antenna ports according to various aspects described herein, transmitted via REs corresponding to the patterns ‘B’-‘E’ in FIG. 2. In FIG. 6, antenna ports 15-22 are in REs corresponding to pattern ‘B’ in FIG. 2, antenna ports 23-30 are in REs corresponding to pattern ‘C,’ antenna ports 31-38 are in REs corresponding to pattern D,′ and antenna ports 39-46 are in REs corresponding to pattern ‘E.’ However, in various aspects, sets of 8 consecutive CSI-RS antenna ports can be arranged in REs corresponding to any of the patterns indicated in FIG. 2. A more generalized arrangement of CSI-RS signals in a single subframe can be seen in FIG. 6, illustrating a time-frequency chart of a subframe showing possible REs used for transmitting CSI-RS for up to 40 antenna ports according to various aspects described herein. In FIG. 6, each set of 8 REs that correspond to one of the patterns ‘A’-‘E’ in FIG. 2 can have CSI-RS transmitted therein for one of the following sets of antenna ports: {15-22}, {23-30}, {31-38}, {39-46}, and {47-54}, or, where less than 40 CSI-RS are to be transmitted in the subframe, some of the REs corresponding to one or more of the patterns ‘A’-‘E’ can be used for transmission of the physical downlink shared channel (PDSCH) instead of CSI-RS. These (up to five) sets of eight CSI-RS can be arranged in any order in the (up to five) patterns ‘A’-‘E,’ as indicated in FIG. 6.

In various embodiments, the modulation employed can depend on the antenna port indices associated with each CSI-RS. For example, the initialization seed for the pseudo-random sequence used to generate the reference signal sequence can depend on the antenna port index, such as by employing a different initialization seed for each set of 8 antenna port indices (e.g., a first initialization seed for ports 15-22, a second seed for ports 23-30, etc.). By employing the same initialization seed for antenna ports 15-22, backwards compatibility can be maintained. Alternatively, the initialization seed can be changed every N antenna port indices, where N is a different number than 8 (e.g., 2, 4, etc.), or can change every N antenna port indices for antenna port indices greater than 22, but apply a common initialization seed for antenna ports 15-22, providing for backwards compatibility.

In other embodiments, the modulation sequence can depend on the subcarrier index, k. For example, the initialization seed can be changed every N subcarriers, (e.g., 1, 2, 4, etc.), and can be repeated (or not) every M subcarriers. In one example, the initialization seed can be changed every 2 subcarriers, and can repeat every 6 subcarriers, providing for common initialization seeds for the following sets of subcarriers: {1, 2, 7, 8}, {3, 4, 9, 10}, and {5, 6, 11, 12}, which can provide for backwards compatibility by providing a common initialization seed for antenna ports 15-22 (which can be selected to match the initialization seed employed in convention LTE-A systems).

In another set of embodiments, the pair of OCCs used to multiplex a pair of antenna ports can be varied (e.g., based on antenna port indices or subcarrier indices) to provide randomized interference from adjacent subcarriers. In conventional LTE-A systems, pairs of subsequent antenna ports (15 and 16, 17 and 18, etc.) are multiplexed with OCCs {1,1} and {1,−1}, where −1 corresponds to an orthogonal frequency division multiplexing (OFDM) symbol l and 1 corresponds to an OFDM symbol l+1, l being the OFDM symbol during which the first CSI-RS signal of the pair is transmitted. In the set of embodiments in which OCCs are varied, one pair of OCCs can be used for some CSI-RS signals (e.g., some or all of those corresponding to antenna ports 15-22 (if all, backwards compatibility can be provided), and potentially some corresponding to antenna ports with indices greater than 22), such as {1,1} and {1,−1}, while other CSI-RS signals can be multiplexed with a different pair of OCCs, such as {1,1} and {−1,1}. In one set of examples, the pair of OCCs employed can change between {{1,1} and {1,−1}} and {{1,1} and {−1,1}} every eight antenna ports. In some such examples, antenna ports 15-22 can be multiplexed with OCCs {1,1} and {1,−1}, providing for backwards compatibility.

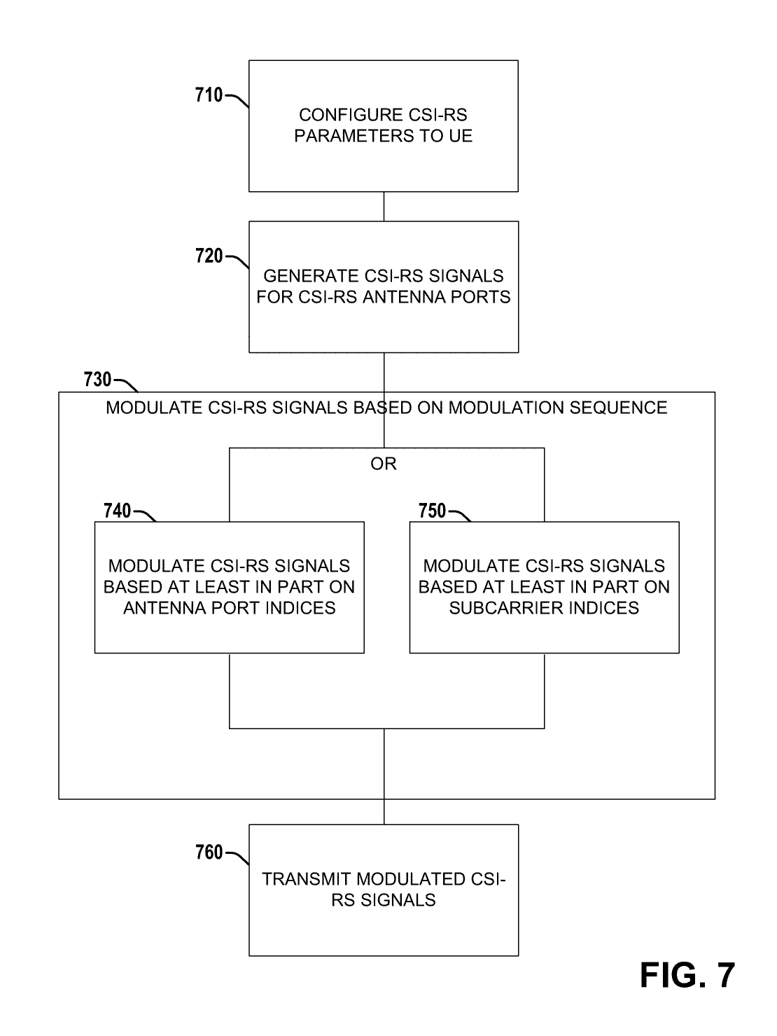

Referring to FIG. 7, illustrated is a flow diagram of a method 700 facilitating scrambling and modulation of greater than eight CSI-RS antenna ports according to various aspects described herein. In various aspects, method 700 can be implemented via an Evolved Universal Terrestrial Radio Access Network (E-UTRAN) Node B (Evolved Node B, eNodeB, or eNB) or other base station in a wireless communications network.

At 710, CSI-RS signal parameters can be configured to a UE (e.g., via higher layer signaling).

At 720, for each of a plurality of antenna ports (e.g., 16, 32, etc.), a CSI-RS signal can be generated.

At 730, the CSI-RS signals can be modulated based at least in part on a modulation sequence. In some aspects, this can include, as indicated at 740, modulating at least a portion of the CSI-RS signals based at least in part on antenna port indices associated with those CSI-RS signals (e.g., employing an initialization seed of a pseudo-random sequence that depends at least in part on antenna port index, varying OCCs for some antenna port indices, etc.). In other aspects, 730 can include, as indicated at 750, modulating at least a portion of the CSI-RS signals based at least in part on subcarrier indices of the subcarriers in which they are to be transmitted (e.g., employing an initialization seed of a pseudo-random sequence that depends at least in part on subcarrier index, varying OCCs for some subcarrier indices, etc.).

At 760, the modulated CSI-RS signals can be transmitted (e.g., via one or more downlink subframes of an eNB) to the UE in REs according to any of a variety of arrangements of CSI-RS, as discussed herein.

As noted above, FD-MIMO generally requires support of more than 8 CSI-RS antenna ports to facilitate channel measurements from larger numbers of transceiver units (TXRUs) than employed by conventional systems. For example, FIG. 5, discussed above, illustrates an example configuration of CSI-RS for channel estimation of 32 antenna ports.

In the example configuration of FIG. 5, it can be seen that OFDM symbols 9 and 10 can be fully occupied by the CSI-RS signals corresponding to 24 antenna ports (in the example shown, ports 15-38). To reduce the peak-to-average power ratio (PAPR) and improve cross-correlation properties between potentially collided CSI-RS signals from different cells, embodiments discussed herein can employ CSI-RS modulation that varies based on antenna port indices or subcarrier indices, for example, modulation with a pseudo-random sequence that depends on the antenna port index.

In a first set of embodiments, the initialization seed for the pseudo-random sequence generator can change every 8 CSI-RS antenna ports. To support backwards compatibility, the initialization seed of the first 8 CSI-RS antenna ports (15-22) can be the same as in conventional LTE-A systems, such as that described in Rel-12 of the LTE-A specification: cᵢₙᵢₜ=2¹⁰·(7·(nₛ+1)+l+1)·(2·N_{ID}^{CSI}+1)+2·N_{ID}^{CSI}+N_{CP}. In contrast, in the first set of embodiments, the initialization seed can be based at least in part on the antenna port index, for example, as in equation 2 (with the changes underlined):

$${c}_{init} = {2}^{10} \cdot ( 7 \cdot ( {n}_{s} + 1 ) + l + 1 ) \cdot ( 2 \cdot {N}_{ID}^{CSI} + 1 \underline{+ {N}_{AP}^{CSI}} ) + 2 \cdot {N}_{ID}^{CSI} + {N}_{CP} , \qquad ( 2 )$$

where N_{AP}^{CSI} is 0 for antenna ports 15-22 and increments by 1 every eight antenna ports, as indicated in equation 3:

$${N}_{AP}^{CSI} = \{ \begin{matrix}0 & p = 15 , 16 , 17 , 18 , 19 , 20 , 21 , 22 \\ 1 & p = 23 , 24 , 25 , 26 , 27 , 28 , 29 , 30 \\ 2 & p = 31 , 32 , 33 , 34 , 35 , 36 , 37 , 38 \\ & M\end{matrix} , \qquad ( 3 )$$

In a second set of embodiments, the initialization seed of the pseudo-random sequence can change every N antenna ports or every N antenna ports after the first 8 antenna ports, for N other than eight (e.g., N equal to two or four, etc.).

In a third set of embodiments, the OCC codes used for modulating CSI-RS antenna port pairs can be swapped from {[1 1], [1 −1]} to {[1 1], [−1 1]} for some of the new CSI-RS antenna ports or for some subcarriers. For example, the new OCC can be applied to one or more of antenna ports 23-30, 39-46, etc., for example, by switching OCCs every eight antenna ports.

In a fourth set of embodiments, the initialization seed of the pseudo-random sequence employed for modulating CSI-RS signals can depend on the subcarrier index k.

Example 1 is a system configured for use in an Evolved NodeB (eNB), comprising a processor and transmitter circuitry. The processor is configured to determine Channel State Information (CSI)-Reference Signal (RS) signal parameters for a user equipment (UE) and modulate a plurality of CSI-RS signals based on a modulation sequence. The transmitter circuitry is configured to transmit the CSI-RS signal parameters and the modulated plurality of CSI-RS signals to the UE, wherein each of the plurality of CSI-RS signals is associated with a distinct CSI-RS antenna port of a plurality of CSI-RS antenna ports of the transmitter circuitry, and wherein the modulation sequence is based at least in part on indices of the CSI-RS antenna ports associated with the plurality of CSI-RS signals.

Example 2 includes the subject matter of example 1, wherein the plurality of CSI-RS antenna ports comprises more than eight CSI-RS antenna ports.

Example 3 includes the subject matter of example 1, wherein the plurality of CSI-RS antenna ports comprises at most sixty-four CSI-RS antenna ports.

Example 4 includes the subject matter of example 1, wherein the CSI-RS signal parameters are transmitted via higher layer signaling.

Example 5 includes the subject matter of any of examples 1-4, including or omitting optional features, wherein the processor being configured to modulate the plurality of CSI-RS signals comprises the processor being configured to modulate the plurality of CSI-RS signals via a plurality of quadrature phase-shift keying (QPSK) symbols.

Example 6 includes the subject matter of any variation of example 5, wherein a pseudo random initialization seed associated with the plurality of QPSK symbols is based at least in part on the indices of the CSI-RS antenna ports associated with the plurality of CSI-RS signals.

Example 7 includes the subject matter of any variation of example 6, wherein the same pseudo random initialization seed is employed for CSI-RS signals associated with sets of N consecutive CSI-RS antenna ports of the plurality of CSI-RS antenna ports.

Example 8 includes the subject matter of any variation of example 7, wherein N is eight.

Example 9 includes the subject matter of any of examples 1-4, including or omitting optional features, wherein the processor being configured to modulate the plurality of CSI-RS signals comprises the processor being configured to multiplex pairs of CSI-RS signals with each other based on pairs of orthogonal complementary codes (OCCs).

Example 10 includes the subject matter of any variation of example 9, wherein the processor being configured to modulate the plurality of CSI-RS signals comprises the processor being configured to multiplex a first pair of the pairs of CSI-RS signals with a first pair of OCCs, and to multiplex a second pair of the pairs of CSI-RS signals with a second pair of OCCs, wherein the second pair of OCCs comprises at least one OCC distinct from the OCCs of the first pair of OCCs.

Example 11 includes the subject matter of example 1, wherein the processor being configured to modulate the plurality of CSI-RS signals comprises the processor being configured to modulate the plurality of CSI-RS signals via a plurality of quadrature phase-shift keying (QPSK) symbols.

Example 12 includes the subject matter of example 1, wherein the processor being configured to modulate the plurality of CSI-RS signals comprises the processor being configured to multiplex pairs of CSI-RS signals with each other based on pairs of orthogonal complementary codes (OCCs).

Example 13 is a non-transitory machine readable medium comprising instructions that, when executed, cause an Evolved NodeB (eNB) to: configure Channel State Information (CSI)-Reference Signal (RS) signal parameters to a user equipment (UE) via higher layer signaling; modulate a plurality of CSI-RS signals via a modulation sequence based at least in part on the configured CSI-RS signal parameters, wherein the modulation sequence is based at least in part on antenna port indices associated with each of the plurality of CSI-RS signals; and transmit the modulated plurality of CSI-RS signals via one or more downlink subframes of the eNB.

Example 14 includes the subject matter of example 13, wherein the CSI-RS signal parameters indicate the antenna port indices associated with each of the plurality of CSI-RS signals, a scrambling identity, a CSI-RS pattern index, a CSI-RS periodicity, and a subframe offset.

Example 15 includes the subject matter of example 13, wherein each of the antenna port indices is associated with a distinct antenna port of a plurality of antenna ports, wherein the plurality of antenna ports comprises more than eight antenna ports.

Example 16 includes the subject matter of any of examples 13-15, including or omitting optional features, wherein the modulation sequence is based at least in part on a pseudo random sequence initialization seed.

Example 17 includes the subject matter of any variation of example 16, wherein the pseudo random sequence initialization seed is based at least in part on the antenna port index associated with each of the plurality of CSI-RS signals.

Example 18 includes the subject matter of any variation of example 17, wherein, the pseudo random sequence initialization seed associated with at least one CSI-RS signal associated with one of the first eight antenna port indices of the antenna port indices is distinct from the pseudo random sequence initialization seed associated with at least one CSI-RS signal associated with an antenna port index distinct from the first eight antenna port indices.

Example 19 includes the subject matter of any variation of example 17, wherein, for the CSI-RS signals associated with a first eight antenna port indices of the antenna port indices, the pseudo random sequence initialization seed is cᵢₙᵢₜ=2¹⁰·(7·(nₛ+1)+l+1)·(2·N_{ID}^{CSI}+1)+2·N_{ID}^{CSI}+N_{CP} at the start of each orthogonal frequency division multiplexing (OFDM) symbol of the eNB, wherein nₛ is a slot number within a radio frame, l is an OFDM symbol number of each OFDM symbol, N_{ID}^{CSI} equals a physical layer cell identity of the cell or a value configured via higher layer signaling, and N_{CP} equals 1 for a normal cyclic prefix (CP) transmission and 0 for an extended CP transmission.

Example 20 includes the subject matter of any variation of example 17, wherein, for the CSI-RS signals associated with each antenna port index of the antenna port indices, the pseudo random sequence initialization seed is cᵢₙᵢₜ=2¹⁰. (7·(nₛ+1)+l+1)·(2·N_{ID}^{CSI}+1+N_{AP}^{CSI})+2·N_{ID}^{CSI}+N_{CP} at the start of each orthogonal frequency division multiplexing (OFDM) symbol of the eNB, wherein nₛ is a slot number within a radio frame, l is an OFDM symbol number of each OFDM symbol, N_{ID}^{CSI} equals a physical layer cell identity of the cells or a value configured via higher layer signaling, N_{CP} equals 1 for a normal cyclic prefix (CP) transmission and 0 for an extended CP transmission, and Ng equals 0 for the first N antenna port indices and increments by 1 for each subsequent set of N antenna port indices.

Example 21 includes the subject matter of any variation of example 20, wherein N is one of two, four, or eight.

Example 22 includes the subject matter of any of examples 13-15, including or omitting optional features, wherein each of the CSI-RS signal is modulated based at least in part on an associated orthogonal cover code (OCC) of a plurality of OCCs, wherein each of a first eight CSI-RS signals of the plurality of CSI-RS signals is associated with either a first OCC or a second distinct OCC of the plurality of OCCs, and wherein at least one subsequent CSI-RS signal of the plurality of CSI-RS signals is associated with a third OCC that is distinct from the first OCC and the second OCC.

Example 23 includes the subject matter of any variation of example 22, wherein the third OCC is a {−1, 1} OCC, wherein −1 corresponds to an orthogonal frequency division multiplexing (OFDM) symbol land 1 corresponds to an OFDM symbol l+1, wherein l is an OFDM symbol during which the at least one subsequent CSI-RS signal is transmitted.

Example 24 includes the subject matter of any of examples 13-15, including or omitting optional features, wherein the plurality of CSI-RS signals are transmitted during an even number of symbols, wherein the even number of symbols is a smallest even number during which the plurality of CSI-RS signals are transmittable.

Example 25 includes the subject matter of example 13, wherein the modulation sequence is based at least in part on a pseudo random sequence initialization seed.

Example 26 includes the subject matter of example 13, wherein each of the CSI-RS signal is modulated based at least in part on an associated orthogonal cover code (OCC) of a plurality of OCCs, wherein each of a first eight CSI-RS signals of the plurality of CSI-RS signals is associated with either a first OCC or a second distinct OCC of the plurality of OCCs, and wherein at least one subsequent CSI-RS signal of the plurality of CSI-RS signals is associated with a third OCC that is distinct from the first OCC and the second OCC.

Example 27 includes the subject matter of example 13, wherein the plurality of CSI-RS signals are transmitted during an even number of symbols, wherein the even number of symbols is a smallest even number during which the plurality of CSI-RS signals are transmittable.

Example 28 is a system configured for use in an Evolved NodeB (eNB), comprising a processor and transmitter circuitry. The processor is configured to: generate Channel State Information (CSI)-Reference Signal (RS) signal parameters for a user equipment (UE); and modulate a plurality of CSI-RS signals based on a modulation sequence. The transmitter circuitry is configured to transmit the CSI-RS signal parameters and the modulated plurality of CSI-RS signals to the UE, wherein each of the plurality of CSI-RS signals is transmitted over a subcarrier of a plurality of subcarriers, and wherein each of the plurality of CSI-RS signals is associated with a distinct CSI-RS antenna port of a plurality of CSI-RS antenna ports of the transmitter circuitry, and wherein the modulation sequence is based at least in part on subcarrier indices of the plurality of subcarriers over which the plurality of CSI-RS signals are transmitted.

Example 29 includes the subject matter of example 28, wherein the transmitter circuitry is configured to transmit the modulated plurality of CSI-RS signals to the UE every T milliseconds, where T is a multiple of 5.

Example 30 includes the subject matter of any of examples 28-29, including or omitting optional features, wherein the plurality of CSI-RS antenna ports comprises more than eight CSI-RS antenna ports.

Example 31 includes the subject matter of example 28, wherein the plurality of CSI-RS antenna ports comprises more than eight CSI-RS antenna ports.

Example 32 is a system configured for use in an Evolved NodeB (eNB), comprising means for processing and means for transmitting. The means for processing is configured to: determine Channel State Information (CSI)-Reference Signal (RS) signal parameters for a user equipment (UE) and modulate a plurality of CSI-RS signals based on a modulation sequence. The means for transmitting is configured to transmit the CSI-RS signal parameters and the modulated plurality of CSI-RS signals to the UE, wherein each of the plurality of CSI-RS signals is associated with a distinct CSI-RS antenna port of a plurality of CSI-RS antenna ports of the means for transmitting, and wherein the modulation sequence is based at least in part on indices of the CSI-RS antenna ports associated with the plurality of CSI-RS signals.

Example 33 is a system configured for use in an Evolved NodeB (eNB), comprising means for processing and means for transmitting. The means for processing is configured to: generate Channel State Information (CSI)-Reference Signal (RS) signal parameters for a user equipment (UE); and modulate a plurality of CSI-RS signals based on a modulation sequence. The means for transmitting is configured to transmit the CSI-RS signal parameters and the modulated plurality of CSI-RS signals to the UE, wherein each of the plurality of CSI-RS signals is transmitted over a subcarrier of a plurality of subcarriers, and wherein each of the plurality of CSI-RS signals is associated with a distinct CSI-RS antenna port of a plurality of CSI-RS antenna ports of the means for transmitting, and wherein the modulation sequence is based at least in part on subcarrier indices of the plurality of subcarriers over which the plurality of CSI-RS signals are transmitted.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

1. A system configured for use in an Evolved NodeB (eNB), comprising:
a processor configured to:
determine Channel State Information (CSI)-Reference Signal (RS) signal parameters for a user equipment (UE); and
modulate a plurality of CSI-RS signals based on a modulation sequence; and
transmitter circuitry configured to transmit the CSI-RS signal parameters and the modulated plurality of CSI-RS signals to the UE, wherein each of the plurality of CSI-RS signals is associated with a distinct CSI-RS antenna port of a plurality of CSI-RS antenna ports of the transmitter circuitry,
wherein the modulation sequence is based at least in part on indices of the CSI-RS antenna ports associated with the plurality of CSI-RS signals.

2. The system of claim 1, wherein the plurality of CSI-RS antenna ports comprises more than eight CSI-RS antenna ports.

3. The system of claim 1, wherein the plurality of CSI-RS antenna ports comprises at most sixty-four CSI-RS antenna ports.

4. The system of claim 1, wherein the CSI-RS signal parameters are transmitted via higher layer signaling.

5. The system of claim 1, wherein the processor being configured to modulate the plurality of CSI-RS signals comprises the processor being configured to modulate the plurality of CSI-RS signals via a plurality of quadrature phase-shift keying (QPSK) symbols.

6. The system of claim 5, wherein a pseudo random initialization seed associated with the plurality of QPSK symbols is based at least in part on the indices of the CSI-RS antenna ports associated with the plurality of CSI-RS signals.

7. The system of claim 6, wherein the same pseudo random initialization seed is employed for CSI-RS signals associated with sets of N consecutive CSI-RS antenna ports of the plurality of CSI-RS antenna ports.

8. The system of claim 7, wherein N is eight.

9. The system of claim 1, wherein the processor being configured to modulate the plurality of CSI-RS signals comprises the processor being configured to multiplex pairs of CSI-RS signals with each other based on pairs of orthogonal complementary codes (OCCs).

10. The system of claim 9, wherein the processor being configured to modulate the plurality of CSI-RS signals comprises the processor being configured to multiplex a first pair of the pairs of CSI-RS signals with a first pair of OCCs, and to multiplex a second pair of the pairs of CSI-RS signals with a second pair of OCCs, wherein the second pair of OCCs comprises at least one OCC distinct from the OCCs of the first pair of OCCs.

11. A non-transitory machine readable medium comprising instructions that, when executed, cause an Evolved NodeB (eNB) to:
configure Channel State Information (CSI)-Reference Signal (RS) signal parameters to a user equipment (UE) via higher layer signaling;
modulate a plurality of CSI-RS signals via a modulation sequence based at least in part on the configured CSI-RS signal parameters, wherein the modulation sequence is based at least in part on antenna port indices associated with each of the plurality of CSI-RS signals; and
transmit the modulated plurality of CSI-RS signals via one or more downlink subframes of the eNB.

12. The non-transitory machine readable medium of claim 11, wherein the CSI-RS signal parameters indicate the antenna port indices associated with each of the plurality of CSI-RS signals, a scrambling identity, a CSI-RS pattern index, a CSI-RS periodicity, and a subframe offset.

13. The non-transitory machine readable medium of claim 11, wherein each of the antenna port indices is associated with a distinct antenna port of a plurality of antenna ports, wherein the plurality of antenna ports comprises more than eight antenna ports.

14. The non-transitory machine readable medium of claim 11, wherein the modulation sequence is based at least in part on a pseudo random sequence initialization seed.

15. The non-transitory machine readable medium of claim 14, wherein the pseudo random sequence initialization seed is based at least in part on the antenna port index associated with each of the plurality of CSI-RS signals.

16. The non-transitory machine readable medium of claim 15, wherein, the pseudo random sequence initialization seed associated with at least one CSI-RS signal associated with one of the first eight antenna port indices of the antenna port indices is distinct from the pseudo random sequence initialization seed associated with at least one CSI-RS signal associated with an antenna port index distinct from the first eight antenna port indices.

17. The non-transitory machine readable medium of claim 15, wherein, for the CSI-RS signals associated with a first eight antenna port indices of the antenna port indices, the pseudo random sequence initialization seed is
cᵢₙᵢₜ=2¹⁰·(7·(nₛ+1)+l+1)·(2·N_{ID}^{CSI}+1)+2·N_{ID}^{CSI}+N_{CP}
at the start of each orthogonal frequency division multiplexing (OFDM) symbol of the eNB, wherein n₃ is a slot number within a radio frame, l is an OFDM symbol number of each OFDM symbol, N_{ID}^{CSI} equals a physical layer cell identity of the cell or a value configured via higher layer signaling, and N_{CP} equals 1 for a normal cyclic prefix (CP) transmission and 0 for an extended CP transmission.

18. The non-transitory machine readable medium of claim 15, wherein, for the CSI-RS signals associated with each antenna port index of the antenna port indices, the pseudo random sequence initialization seed is
cᵢₙᵢₜ=2¹⁰·(7·(nₛ+1)+l+1)·(2·N_{ID}^{CSI}+1+N_{AP}^{CSI})+2·N_{ID}^{CSI}+N_{CP}
at the start of each orthogonal frequency division multiplexing (OFDM) symbol of the eNB, wherein n₃ is a slot number within a radio frame, l is an OFDM symbol number of each OFDM symbol, N_{ID}^{CSI} equals a physical layer cell identity of the cells or a value configured via higher layer signaling, N_{CP} equals 1 for a normal cyclic prefix (CP) transmission and 0 for an extended CP transmission, and N_{AP}^{CSI} equals 0 for the first N antenna port indices and increments by 1 for each subsequent set of N antenna port indices.

19. The non-transitory machine readable medium of claim 18, wherein N is one of two, four, or eight.

20. The non-transitory machine readable medium of claim 11, wherein each of the CSI-RS signal is modulated based at least in part on an associated orthogonal cover code (OCC) of a plurality of OCCs, wherein each of a first eight CSI-RS signals of the plurality of CSI-RS signals is associated with either a first OCC or a second distinct OCC of the plurality of OCCs, and wherein at least one subsequent CSI-RS signal of the plurality of CSI-RS signals is associated with a third OCC that is distinct from the first OCC and the second OCC.

21. The non-transitory machine readable medium of claim 20, wherein the third OCC is a {−1, 1} OCC, wherein −1 corresponds to an orthogonal frequency division multiplexing (OFDM) symbol l and 1 corresponds to an OFDM symbol l+1, wherein l is an OFDM symbol during which the at least one subsequent CSI-RS signal is transmitted.

22. The non-transitory machine readable medium of claim 11, wherein the plurality of CSI-RS signals are transmitted during an even number of symbols, wherein the even number of symbols is a smallest even number during which the plurality of CSI-RS signals are transmittable.

23. A system configured for use in an Evolved NodeB (eNB), comprising:
a processor configured to:
generate Channel State Information (CSI)-Reference Signal (RS) signal parameters for a user equipment (UE); and
modulate a plurality of CSI-RS signals based on a modulation sequence; and
transmitter circuitry configured to transmit the CSI-RS signal parameters and the modulated plurality of CSI-RS signals to the UE, wherein each of the plurality of CSI-RS signals is transmitted over a subcarrier of a plurality of subcarriers, and wherein each of the plurality of CSI-RS signals is associated with a distinct CSI-RS antenna port of a plurality of CSI-RS antenna ports of the transmitter circuitry,
wherein the modulation sequence is based at least in part on subcarrier indices of the plurality of subcarriers over which the plurality of CSI-RS signals are transmitted.

24. The system of claim 23, wherein the transmitter circuitry is configured to transmit the modulated plurality of CSI-RS signals to the UE every T milliseconds, where T is a multiple of 5.

25. The system of claim 23, wherein the plurality of CSI-RS antenna ports comprises more than eight CSI-RS antenna ports.
